(19) United States
(12) Patent Application Publication
(10) Pub. No.: US 2008/0278379 A1
(43) Pub. Date: Nov. 13, 2008

(54) Antenna

(76) Inventors: Hanyang Wang, Abingdon (GB); Ming Zheng, Farnborough (GB)

Correspondence Address: HARRINGTON & SMITH, PC, 4 RESEARCH DRIVE, SHELTON, CT, 06484-6212, US

(21) Appl. No.: 11/886,358

(22) PCT Filed: Mar. 30, 2005
(86) PCT No.: PCT/IB05/00876

§ 371 Date: Sep. 14, 2007

(51) Int. Cl. H01Q 9/04

(52) U.S. Cl. 343/700 MS

(57) ABSTRACT

An antenna having a first resonant mode and a second resonant mode and including an antenna element, the antenna element including a first portion; a second portion; and at least one bend between the first portion and the second portion, wherein a first part of the first portion opposes a second part of the second portion across a narrow gap and, in use, a maximum of current density for the second resonant mode is at or adjacent each of the first part of the first portion and the second part of the second portion.

### FIELD OF THE INVENTION

Embodiments of the present invention relate to an antenna. In particular they relate to antennas having multiple resonances.

### BACKGROUND TO THE INVENTION

PIFA antennas are widely used in mobile handsets and depending upon their construction they may have multiple resonant frequencies. Such a PIFA may have a central feed and ground and a number of elements separately extending from the feed each of which has a different resonant frequency. In order to save space, a PIFA comprising only one element has been constructed. It has resonant frequencies which correspond to ¼ and ¾ wavelengths. A problem with this type of PIFA is that the impedance for the first and second resonant modes may be significantly different. Therefore although the impedance for the lowest resonant mode may be close to 50 Ohms, the impedance for the second lowest resonant mode would be significantly greater than 50 Ohms.

### BRIEF DESCRIPTION OF THE INVENTION

It would therefore be desirable to provide an antenna having multiple resonant modes that has good impedance matching at both the first and the second lowest resonant modes.

It would additionally be desirable to solve this problem without using a large volume antenna.

It would additionally be desirable to solve this problem without compromising the radiating efficiency of the antenna.

According to one aspect of the invention there is provided an antenna having a first resonant mode and a second resonant mode and comprising an antenna element, the antenna element comprising: a first portion; a second portion; and at least one bend between the first portion and the second portion, wherein a first part of the first portion opposes a second part of the second portion across a narrow gap and, in use, a maximum of current density for the second resonant mode is at or adjacent each of the first part of the first portion and the second part of the second portion.

The proximity of the maximum current densities lowers the impedance of the antenna for the second resonant mode towards 50 Ohms. Although the maximum of current density for the first resonant mode may also be at or near the first part of the first portion, a maximum of current density for the first resonant mode will not be at or near the second part of the second portion. Thus the impedance for the first resonant mode is not significantly affected.

The first part of the first portion may be grounded. This creates a maximum in the Magnetic Field Strength H and a maximum in the current density at the first part.

Typically the gap is less than 5% of the wavelength corresponding to the resonant frequency of the second lowest resonant mode. The gap is a space between the antenna element and need not be free space. It may, for example, be filled with dielectric material.

The second portion may be longer than the first portion. In one implementation, the second portion is twice as long as the first portion, the first portion having a length equivalent to λ/4 (at the second resonant mode) and the second portion having a length equivalent to 2λ/4 (at the second resonant mode).

The second portion may have a bend and in this case, the second part is located at the bend or, between the bend joining the first portion and the second portion and the bend in the second portion. The second portion connects to the bend between the first and second portions at one end and terminates at the other free end. In both the first resonant mode and the second resonant mode, a maximum in the Electric (E) field is developed at the terminating free end of the second portion. The bend in the second portion ensures that the portion of the second portion having a maximum E-field is in free space. This improves the radiation efficiency of the antenna.

The bend in the second portion may be a 90 degree bend. A 90 degree bend provides for the greatest displacement of the terminating free end from the second part. The bend may be adjacent the second part e.g. approximately half way along the second portion.

The first portion may be straight. The bend between the first portion and the second portion may be a 180 degree bend. The second portion may be straight and parallel to the first portion at least from the bend joining the first portion and the second portion to the second part. The parallel arrangement of the first and second portions with a narrow gap therebetween produces a compact, low-volume antenna.

The first resonant mode may be a λ/4 resonant mode having the lowest resonant frequency of the antenna and the second resonant mode may be a 3λ/4 resonant mode having the second lowest resonant frequency of the antenna.

The antenna may be suitable for radio communications. For example, it may be used as an internal antenna in a radio communications device, such as a mobile telephone.

The antenna is in general a dual band antenna covering GSM850 or GSM900 and PCN 1800 or PCS 1900 band. However, if a parasitic element is introduced, the antenna may be a tri-band antenna having a first band for GSM 850 and/or GSM 900, a second band for DCS 1800/PCN 1800, and a third band for PCS 1900.

The antenna may be a PIFA having a feed and a ground in the first portion.

According to another aspect of the invention there is provided a multi-resonance antenna having a lowest resonant frequency and a second lowest resonant frequency and comprising an antenna element that comprises:

a first grounded part; and a second part that opposes the first grounded part across a narrow gap, wherein the portion of the antenna element that extends between the first grounded part and the second part has a length equivalent to 2λ/4 at the second lowest resonant frequency.

According to another aspect of the invention there is provided an antenna element having a length L comprising: a first portion that is straight; a second portion that has a bend and a 180 degree bend between the first portion and the second portion, wherein the second portion is straight, parallel to the first portion and separated therefrom by a narrow gap at least from the 180 degree bend to the bend in the second portion and has a second part located between the 180 degree bend and the bend in the second portion such that the second part of the second portion opposes a first part of the first portion across the narrow gap between the first and second portions.

The first portion may have a length of approximately L/3. The second portion may have a length of approximately 2 L/3. The second part may be located approximately half-way along the length of the second portion.

### BRIEF DESCRIPTION OF THE DRAWINGS

For a better understanding of the present invention reference will now be made by way of example only to the accompanying drawings in which:

FIG. 1 schematically illustrates a Planar Inverted F antenna (PIFA) 2.

FIG. 2A illustrates how the magnitude of the Magnetic Field Strength (H) varies along the length of the antenna element at the lowest resonant mode;

FIG. 2B illustrates how the magnitude of the Electric Field (E) varies along the length of the antenna element at the lowest resonant mode;

FIG. 3A illustrates how the magnitude of the Magnetic Field Strength (H) varies along the length of the antenna element at the second lowest resonant mode;

FIG. 3B illustrates how the magnitude of the Electric Field (E) varies along the length of the antenna element at the second lowest resonant mode;

FIG. 4 schematically illustrates the current direction and density for the second lowest resonant mode of the antenna element illustrated in FIG. 1;

FIG. 5 schematically illustrates a radio communications device;

FIG. 6 schematically illustrates the return loss for the antenna illustrated in FIG. 1; and

FIG. 7 schematically illustrates an antenna according to another embodiment of the invention.

FIG. 8 schematically illustrates the return loss for the antenna illustrated in FIG. 7.

### DETAILED DESCRIPTION OF EMBODIMENTS OF THE INVENTION

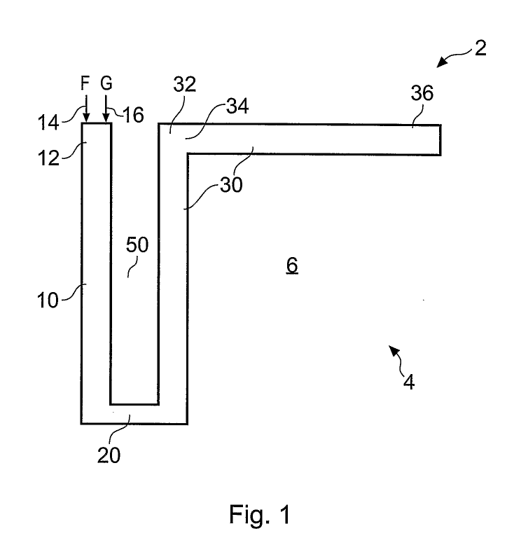

FIG. 1 schematically illustrates a planer inverted F antenna (PIFA) 2. The antenna 2 comprises an antenna element 4, and a ground plane 6. The antenna element 4 has a feed pin 14 and a ground pin 16 at a first part 12. The feed pin 14 and the ground pin 16 can be swapped. The ground pin 16 connects the antenna element 4 to the ground plane 6. The feed pin 14 provides a signal for driving the antenna 4. The antenna element 4, being a PIFA, is planar and typically lies within a plane that is parallel to the ground plane 6.

The antenna 2 has at least two resonant modes of operation. The first resonant mode is the lowest frequency resonant mode. It corresponds to a λ/4 resonant mode of the PIFA. The second resonant mode is the second lowest frequency resonant mode of the antenna. It corresponds to the 3λ/4 resonant mode of the PIFA. Consequently, in the first resonant mode, the antenna 2 has a resonant frequency that corresponds to a wavelength λ₁, where λ₁=4 L, L being the electrical length of the antenna element 4. In the second resonant mode, there is a resonant frequency corresponding to a wavelength λ₂ equal to 4 L/3.

The electrical length will differ from the physical length because of capacitive and/or inductive loading of the antenna element 4. This may be inherent because of, for example, the capacitance arising from the separation between the antenna element 4 and the ground plane 6. However, it may also be modified by, for example, widening the antenna element 4 in areas of high electric field and narrowing the antenna element or introducing bends in areas of high magnetic field strength H.

The antenna element 4 comprises a first portion 10 that extends in a straight line from the first part 12 to a first bend 20 and a second portion 30 that extends from the first bend 20 through a second bend 34 to terminate at a terminating free end 36. In this example, the first bend 20 is a 180° U bend and the second portion extends in a straight line, parallel to the first portion 10 between the first bend 20 and the second bend 34. A narrow gap 50 separates the first portion 10 from the second portion 30 between the first bend 20 and second bend 34. In this example, the second bend 34 is a 90° bend, so that the second portion extends in a direction that is 90° to the first portion 10 before terminating at the terminating free end 36. The second portion 30 has a second part 32 that is located between the second bend 34 and the first bend 20 and approaches the first part 12 of the first portion 10 across the gap 50. In the example shown, the second part 32 is at/adjacent the second bend 34.

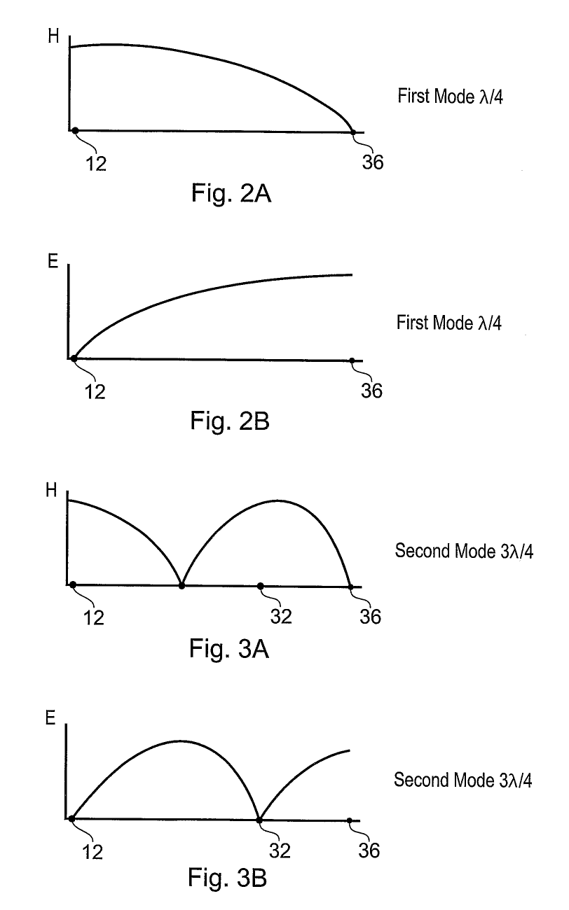

Positioning the second bend 34 as near as possible to the second part 32 ensures that the terminating free end 36 is positioned as far as possible from the first portion 10 as does the use of a 90° bend as the second bend 34. This improves the radiating efficiency of the antenna 2 as in the first resonant mode and the second resonant mode the electric field is a maximum at the terminating free end 36 (see FIGS. 2B and 3B). It should however be appreciated that different positions may be used for the second bend 34 and different values used for the size of the second bend 34.

The described geometry in which the first bend is a 180° U bend and the part of the second portion 30 between the first bend 20 and the second part 32 extends parallel to the first portion 10 reduces the area occupied by the antenna element 4. However, other geometries are possible. The important feature of the geometry, is that the portions of the antenna element 4 where the H field (current density) is very large in the second resonant mode should be brought close together so that they oppose one another across a narrow gap. The coupling arising from the proximity of the large H field (current density) reduces the impedance of the antenna 2 in the second resonant mode.

FIG. 2A illustrates how the magnitude of the magnetic field strength (H) varies along the length of the antenna element 4 at the lowest resonant mode. It can be seen that the magnetic field strength H is maximum at the first part 12, where the first portion 10 is grounded by a ground pin 16 and is minimum at the terminating free end 36. It varies sinusoidally between these ends of the antenna element with the length of the antenna element 4 corresponding to a quarter wavelength of the sinusoid.

FIG. 2B illustrates how the magnitude of the electric field (E) varies along the electrical length of the antenna element 4 at the lowest resonant mode. The electric field E is 90° out of phase with the H field and consequently has a minimum at the first part 12 of the first portion 10 where the ground pin 16 connects and has a maximum value at the terminating free end 36 of the second portion 30. It varies sinusoidally between these ends of the antenna element with the electrical length of the antenna element 4 corresponding to a quarter wavelength of the sinusoid.

The FIG. 3A illustrates how the magnitude of the magnetic field strength (H) varies along the electrical length of the antenna element 4 at the second lowest resonant mode, the 3λ/4 mode. As in FIG. 2A, the H field varies sinusoidally along the electrical length of the antenna element 4. However, the electrical length of the antenna element in this resonant mode corresponds to ¾ of the wavelength of the sinusoid. The H field is maximum at the first part 12 of the first portion 10 where the ground pin connects and is also maximum at the second part 32 of the second portion. In order for the second part 32 in FIG. 1 to correspond with the maximum in the H field in FIG. 3A, then the electrical length of the antenna element 4 between the first part 12 and the second part 32 should correspond to half the wavelength of the sinusoid in FIG. 3A. That is the electrical length between the second part 32 and the first part 12 along the antenna element 4 should correspond to λ/2, where λ is the wave length corresponding to the resonant frequency at the second resonant mode. This may be simply achieved, as in FIG. 1, by having the electrical length of the first portion 10, the electrical length of the second portion between the first bend 20 and the second part 32 and the electrical length of the second portion between the second part 32 and the terminating free end 36 be the same length of λ₂/4 where λ₂ is the wavelength corresponding to the resonant frequency at the second resonant mode.

FIG. 3B illustrates how the magnitude of the electric field (E) varies along the length of the antenna element 4 at the second lowest resonant mode. The electric field in FIG. 3B is 90° out of phase with the H field in FIG. 3A. The electric field is therefore minimum at the first part 32 and maximum at the terminating free end 36.

It should consequently be appreciated that the geometry of FIG. 1 brings the parts of the antenna element 4 where the H field is very large/maximum (for the second resonant mode) close together i.e. first part 12 and the second part 32 oppose each other across a narrow gap 50. It should also be appreciated that the invention is not limited to the specific geometry illustrated and extends to all geometries that bring the parts of the antenna element where the H field is very large/maximum for the second resonant mode close together.

It should also be appreciated that the geometry of the antenna in FIG. 1 ensures that the terminating free end 36 of the antenna element 4 where the E field is maximum for both the first mode and the second mode is in free space. Again it should be appreciated that other geometries may also achieve this and form embodiments of this invention.

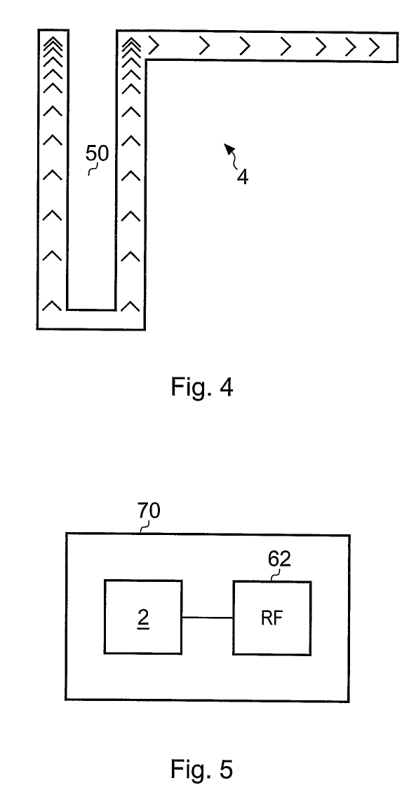

FIG. 4 schematically illustrates the current density for the antenna element 4 illustrated in FIG. 1 for the second lowest resonant mode i.e. the 3λ/4 resonant mode. It is apparent from this figure that the maximum current densities (maximum H field) oppose each other across the gap 50.

FIG. 5 illustrates a radio communications device 70 such as a mobile telephone, comprising, as an internal antenna, the antenna 2 and radio frequency circuitry 62 feeding the antenna 2.

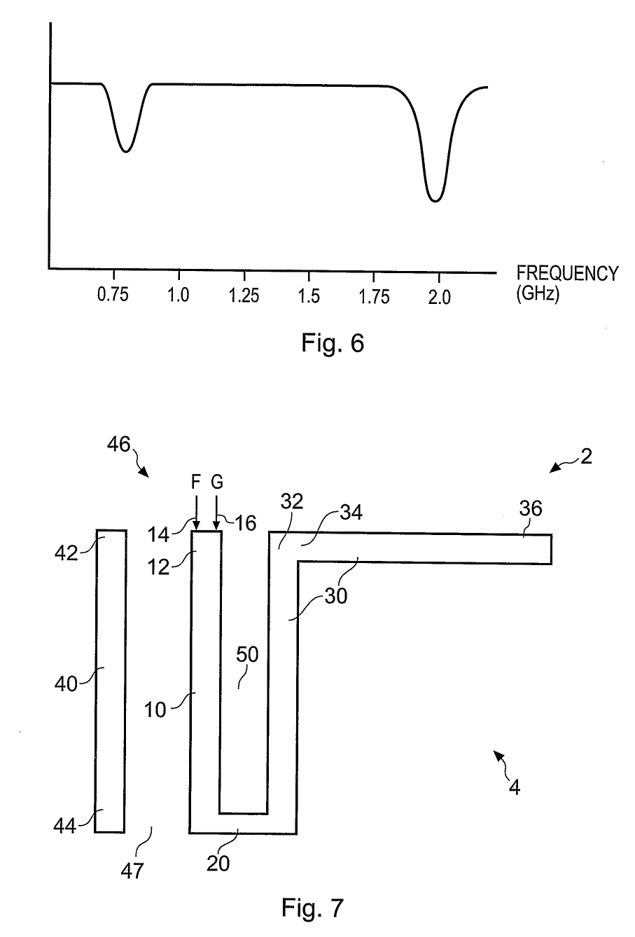

FIG. 6 illustrates an example of the return loss S11 associated with the antenna 2 illustrated in FIG. 1. It will be appreciated that the antenna 2 has two resonances. The lowest resonance may be used for the US-GSM 850 and/or EGSM 900 band. The next resonance forms a band that covers the DCS 1800/PCN 1800 or PCS 1900 band. The antenna 2 may consequently be operated as a dual-band antenna.

FIG. 7 schematically illustrates an antenna arrangement 46 comprising a planer inverted F antenna (PIFA) 2 as illustrated in FIG. 1 and a parasitic PIFA antenna element 40. Similar references are used in FIG. 7 to those used in FIG. 1 to designate similar features.

A first portion 42 of the parasitic antenna element 40 opposes the first part 12 of the antenna element 4 across the gap 47.

It should be appreciated that the geometry of FIG. 7 brings the first part 12 of the antenna element 4 close to the first part 42 of the parasitic antenna element 42.

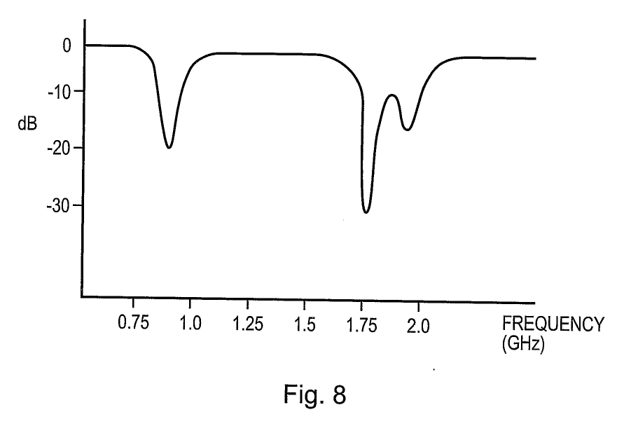

FIG. 8 illustrates an example of the return loss S11 associated with the antenna arrangement 46 illustrated in FIG. 7. It will be appreciated that the antenna arrangement 46 has three resonances. The two resonances arising from the antenna element 4 as described previously in relation to FIG. 6 and an extra resonance arising from the lowest resonance mode of the parasitic element 40.

The lowest resonance of the antenna arrangement 46 may be used for the US-GSM 850 and/or EGSM 900 band. The next two lowest resonances cover the DCS 1800/PCN 1800 and PCS 1900 band. The antenna arrangement 46 may consequently be operated as a tri-band antenna.

Although embodiments of the present invention have been described in the preceding paragraphs with reference to various examples, it should be appreciated that modifications to the examples given can be made without departing from the scope of the invention as claimed.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1. An antenna having a first resonant mode and a second resonant mode and comprising an antenna element, the antenna element comprising: a first portion; a second portion; and at least one bend between the first portion and the second portion, wherein a first part of the first portion opposes a second part of the second portion across a narrow gap and, in use, a maximum of current density for the second resonant mode is at or adjacent each of the first part of the first portion and the second part of the second portion.

2. An antenna as claimed in claim 1, wherein the first part of the first portion is grounded.

3. An antenna as claimed in claim 1, wherein the electrical length of the antenna element between the first part and the second part is 2λ/4, where λ is the wavelength corresponding to the resonant frequency of the second resonant mode.

4. An antenna as claimed in claim 1, wherein the second portion has twice the electrical length of the first portion, the first portion having an electrical length equivalent to λ/4 and the second portion having an electrical length equivalent to 2λ/4, where λ is the wavelength corresponding to the resonant frequency at the second resonant mode.

5. An antenna as claimed in claim 1, wherein the second portion has a bend and the second part is located between the bend between the first portion and the second portion and the bend in the second portion.

6. An antenna as claimed in claim 5, wherein the bend in the second portion is a 90 degree bend.

7. An antenna as claimed in claim 1, wherein the first portion is straight, the bend between the first portion and the second portion is an 180 degree bend and the second portion is straight and parallel to the first portion at least from the bend to the second part.

8. A multi-resonance antenna having a lowest resonant frequency and a second lowest resonant frequency and comprising an antenna element that comprises:
a first grounded part; and a second part that opposes the first grounded part across a narrow gap, wherein the portion of the antenna element that extends between the first grounded part and the second part has an electrical length equivalent to 2λ/4 at the second lowest resonant frequency.

9. An antenna as claimed in claim 8, wherein the second part is located between a bend between the first portion and the second portion and a bend in the second portion.

10. An antenna as claimed in claim 8, wherein the first portion is straight, a 180 degree bend connects the first portion and the second portion and the second portion is straight and parallel to the first portion at least from the 180 degree bend to the second part.

11. An antenna element having an electrical length L comprising: a first portion that is straight; a second portion that has a bend; and a 180 degree bend between the first portion and the second portion,
wherein the second portion is straight, parallel to the first portion and separated therefrom by a narrow gap at least from the 180 degree bend to the bend in the second portion and has a second part located between the 180 degree bend and the bend in the second portion such that the second part of
the second portion opposes a first part of the first portion across the narrow gap between the first and second portions.

12. An antenna as claimed in claim 11, wherein the first part of the first portion is grounded.

13. An antenna as claimed in 11, wherein the electrical length of the antenna element between the first part and the second part is 2λ/4, where λ is the wavelength corresponding to the resonant frequency at the second resonant mode.

14. A radio communications device, such as a mobile telephone, comprising as an internal antenna an antenna as claimed in claim 1.

15. A radio communications device, such as a mobile telephone, comprising as a dual band antenna an antenna as claimed in claim 1.

16. A radio communications device, such as a mobile telephone, comprising as an internal antenna an antenna element as claimed in claim 11.

17. A radio communications device, such as a mobile telephone, comprising as a dual band antenna an antenna element as claimed in claim 11.
